(19) United States
(12) Patent Application Publication
(10) Pub. No.: US 2025/0258560 A1
(43) Pub. Date: Aug. 14, 2025

(54) INDICATED POSITION DETECTING DEVICE AND INDICATED POSITION DETECTING METHOD

(71) Applicant: Wacom Co., Ltd., Saitama (JP)

(72) Inventor: Tomohiro KAGAMI, Saitama (JP)

(21) Appl. No.: 19/193,600

(22) Filed: Apr. 29, 2025

Related U.S. Application Data
(63) Continuation of application No. PCT/JP2024/015536, filed on Apr. 19, 2024.

(30) Foreign Application Priority Data
Apr. 26, 2023 (JP) 2023-072616

(51) Int. Cl. G06F 3/041; G06F 3/044; G06F 3/046

(52) U.S. Cl. CPC G06F 3/0416; G06F 3/0446; G06F 3/046; G06F 2203/04106

(57) ABSTRACT

Provided are an indicated position detecting device and an indicated position detecting method that can suppress a decrease in the accuracy of detecting a position indicated by an indicator. An indicated position detecting device for detecting a position indicated by an indicator includes a first transmission circuit and a second transmission circuit. The first transmission circuit transmits a first transmission signal related to first processing of detecting the position indicated by the indicator. The second transmission circuit transmits a second transmission signal related to second processing different from the first processing. A waveform of the first transmission signal and a waveform of the second transmission signal are orthogonal to each other in the same period.

### BACKGROUND

### Technical Field

The present disclosure relates to an indicated position detecting device and an indicated position detecting method.

### Description of the Related Art

An indicated position detecting device that detects a position indicated by an indicator such as a finger or a pen (indicated position) is included and widely used in electronic apparatuses such as tablet-type information terminals including a flat display (for example, a liquid crystal panel). As a position detecting system to be used in the indicated position detecting device, various systems are provided, such as a resistive film system, an electromagnetic induction system, and a capacitive system.

Of these, as disclosed in Patent Document 1, for example, an indicated position detecting device of the electromagnetic induction system includes a position detecting device including a sensor formed by arranging a large number of loop coils in an X-axis direction and a Y-axis direction of coordinate axes, and an electronic pen as a position indicator of a pen shape that has a resonance circuit including a coil as an example of an inductance element wound around a magnetic core, and a capacitor.

The position detecting device transmits a magnetic field to the electronic pen by supplying a transmission signal of a predetermined frequency to the loop coils of the sensor. The resonance circuit of the electronic pen is configured to have a resonance frequency corresponding to the frequency of the transmission signal. The resonance circuit stores magnetic energy on the basis of an electromagnetic induction action between the resonance circuit and the loop coils of the sensor. Then, the electronic pen feeds back a magnetic field based on the magnetic energy stored in the resonance circuit to the loop coils of the sensor of the position detecting device.

An induced voltage is generated in the loop coils of the sensor due to the magnetic field from the electronic pen. The position detecting device detects coordinate values in the X-axis direction and the Y-axis direction of a position indicated by the electronic pen on the sensor, on the basis of the value of the induced voltage generated in each of the loop coils.

The indicated position detecting device of the electromagnetic induction system enables the indicated position to be input by the electronic pen as an indicator with a relatively high definition, and is thus widely used.

In addition, as for an indicated position detecting device of the capacitive system, which is a system of detecting an indicated position of an indicator (such as a finger or a pen-type position indicator (capacitive pen)) used for a touch panel or the like, there are two kinds of systems, that is, a surface type (surface capacitive type) and a projected type (projected capacitive type). Both of the systems detect the indicated position of the indicator by detecting a change in a state of capacitive coupling between sensor electrodes and the indicator. An indicated position detecting device of a system referred to as a cross point capacitive coupling system, which is an extension of the projected-type capacitive system, has also spread (see Patent Document 2, for example).

FIG. 9 illustrates a configuration of an example of a sensor of the indicated position detecting device of the cross point capacitive system. As illustrated in FIG. 9, the sensor of the indicated position detecting device of the cross point capacitive system is constituted by arranging, for example, a plurality of upper electrodes Ex in the Y-axis direction (vertical direction) of an indication input surface and a plurality of lower electrodes Ey in the X-axis direction (horizontal direction) thereof at respective predetermined intervals in the X-axis direction and the Y-axis direction and arranging the upper electrodes Ex and the lower electrodes Ey such that the upper electrodes Ex and the lower electrodes Ey are orthogonal to each other and spaced from each other with a slight gap. In this case, a predetermined capacitance Co (fixed capacitance) is formed at overlapping parts (cross points) between the upper electrodes Ex and the lower electrodes Ey.

Then, at a position where an indicator 100 such as the position indicator held by a user or a finger of the user is in proximity to or in contact with the indication input surface, a capacitance Cf is formed between the electrodes Ex and Ey at the position and the indicator. Moreover, the indicator 100 is connected to a ground via a predetermined capacitance Cg through a human body. As a result, due to the capacitances Cf and Cg, the capacitance between the upper electrode Ex and the lower electrode Ey changes at the position indicated by the indicator 100. The position detecting device of the cross point capacitive system identifies the position indicated by the indicator 100 within the indication input surface, by detecting the change in this capacitance.

The change in this capacitance is detected by a position detecting circuit 101. The position detecting circuit 101, for example, sets the lower electrodes Ey as transmitting electrodes and supplies a predetermined transmission signal to the transmitting electrodes, and sets the upper electrodes Ex as receiving electrodes, receives a reception signal from the receiving electrodes, and detects a change in current of the reception signal. The position detecting circuit 101 thereby detects the change in the capacitance between the upper electrode Ex and the lower electrode Ey. The position detecting circuit 101 detects the position indicated by the indicator, by simultaneously supplying the transmission signal to all of the transmitting electrodes, and simultaneously performing processing of detecting the change in current of the reception signal from all of the receiving electrodes.

The indicator as a target whose indicated position is to be detected by the sensor for the indicated position detection of the electromagnetic induction system described above is the electronic pen of the electromagnetic induction system. On the other hand, the indicator as a target whose indicated position is to be detected by the sensor for the indicated position detection of the capacitive system is a finger or the capacitive pen. Thus, the targets to be detected are totally different. Accordingly, one indicated position detecting device may include the sensor for the indicated position detection of the electromagnetic induction system and the sensor for the indicated position detection of the capacitive system. This indicated position detecting device can simultaneously detect an indication of the position indicated by the electronic pen, by using the sensor for the indicated position detection of the electromagnetic induction system, while detecting an indication of the position indicated by a finger, for example, by using the sensor for the indicated position detection of the capacitive system.

### PRIOR ART DOCUMENT

### Patent Documents

Patent Document 1: Japanese Patent Laid-open No. 2009-86925
Patent Document 2: Japanese Patent Laid-open No. 2011-3035

### BRIEF SUMMARY

### Technical Problems

Now, an electronic apparatus such as a tablet-type information terminal including a display (for example, a liquid crystal panel) presents a challenge of making provision for frame narrowing, which makes the width of a rim (frame) enclosing the display panel narrower in order to realize miniaturization of the electronic apparatus while maintaining the size of the display panel. Moreover, in order to make provision for the frame narrowing, the electronic apparatus is desired to have a reduced arrangement space for the loop coils and signal lines used in the indicated position detecting device.

However, when an indicated position detecting device of the electromagnetic induction system and an indicated position detecting device of the capacitive system are mounted in one electronic apparatus, loop coils used in the indicated position detecting device of the electromagnetic induction system and signal lines used for the transmission of a transmission signal and the reception of a reception signal in the indicated position detecting device of the capacitive system may be arranged in proximity to each other. In this case, due to magnetic coupling (interference) between the loop coils and the signal lines, an electromagnetic noise is mixed into the loop coils from the signal lines used for the transmission of the transmission signal, and an electromagnetic noise is mixed into the signal lines used for the reception of the reception signal from the loop coils. When an electromagnetic noise is mixed into the loop coils from the signal lines used for the transmission of the transmission signal, the S/N ratio of a magnetic field transmitted from the electronic pen and received in the loop coils is decreased, and consequently, the accuracy of indicated position detection in the indicated position detecting device of the electromagnetic induction system is decreased. In addition, when an electromagnetic noise is mixed into the signal lines used for the reception of the reception signal from the loop coils, the S/N ratio of the reception signal is decreased, and consequently, the accuracy of indicated position detection in the indicated position detecting device of the capacitive system is decreased.

In addition, when the indicated position detecting device of the electromagnetic induction system and the indicated position detecting device of the capacitive system are mounted in one electronic apparatus, the loop coils used in the indicated position detecting device of the electromagnetic induction system, the signal lines used in the indicated position detecting device of the capacitive system, and signal lines (for example, clock lines) used for the transmission of driving signals (for example, clock signals) for driving the display panel may be arranged in proximity to each other. In this case, as a result of the mixing of an electromagnetic noise into the loop coils used in the indicated position detecting device of the electromagnetic induction system and the signal lines used for the reception of the reception signal in the indicated position detecting device of the capacitive system from the signal lines used for the transmission of the driving signals, the S/N ratio of the magnetic field transmitted from the electronic pen and received in the loop coils is decreased, thus decreasing the accuracy of position detection in the indicated position detecting device of the electromagnetic induction system, and the S/N ratio of the reception signal is decreased, thus decreasing the accuracy of position detection in the indicated position detecting device of the capacitive system.

Embodiments of the present disclosure provide an indicated position detecting device and an indicated position detecting method that can suppress a decrease in the accuracy of detecting a position indicated by an indicator.

### Technical Solution

According to the present disclosure, an indicated position detecting device having the following configuration is provided.

[1] An indicated position detecting device for detecting a position indicated by an indicator includes a first transmission circuit, and a second transmission circuit, wherein the first transmission circuit, in operation, transmits a first transmission signal related to first processing of detecting the position indicated by the indicator, wherein the second transmission circuit, in operation, transmits a second transmission signal related to second processing different from the first processing, and wherein a waveform of the first transmission signal and a waveform of the second transmission signal are orthogonal to each other in the same period.

According to the present disclosure, the waveform of the first transmission signal and the waveform of the second transmission signal are orthogonal to each other in the same period, a noise mixed into a reception signal related to the first or second processing due to the first or second transmission signal is suppressed, and thereby a decrease in the position detection accuracy of the first or second processing related to the reception signal is suppressed.

In the following, various embodiments of the present disclosure will be illustrated. The embodiments illustrated in the following can be combined with each other.

[2] In the indicated position detecting device according to [1], a value obtained by subtracting a wave number of the second transmission signal from a wave number of the first transmission signal in the same period is a positive or negative integer.

[3] In the indicated position detecting device according to [1] or [2], the first processing is processing of detecting the position indicated by the indicator by an electromagnetic induction system, and the second processing is processing of detecting the position indicated by the indicator by a capacitive system.

[4] In the indicated position detecting device according to any one of [1] to [3], a transmission period of the first transmission signal at least partially overlaps a transmission period of the second transmission signal.

[5] In the indicated position detecting device according to [4], a start time point and an end time point of the transmission period of the first transmission signal are the same as a start time point and an end time point of the transmission period of the second transmission signal.

[6] The indicated position detecting device according to [1] further includes a display, in which the first processing is processing of detecting the position indicated by the indicator on the display by an electromagnetic induction system, and the second processing is processing of driving the display.

[7] The indicated position detecting device according to [1] further includes a display, in which the first processing is processing of detecting the position indicated by the indicator on the display by a capacitive system, and the second processing is processing of driving the display.

[8] An indicated position detecting device for detecting a position indicated by an indicator includes a first transmission circuit, a second transmission circuit, a first reception circuit, and a second reception circuit, wherein the first transmission circuit, in operation, transmits a first transmission signal related to first processing of detecting the position indicated by the indicator, wherein the second transmission circuit, in operation, transmits a second transmission signal related to second processing of detecting the position indicated by the indicator, wherein the first reception circuit, in operation, receives a first reception signal related to the first processing, wherein the second reception circuit, in operation, receives a second reception signal related to the second processing, and wherein a waveform of the first reception signal and a waveform of the second reception signal are orthogonal to each other in the same period.

[9] In the indicated position detecting device according to [8], a value obtained by subtracting a wave number of the second transmission signal from a wave number of the first transmission signal in the same period is a positive or negative integer.

[10] In the indicated position detecting device according to [8] or [9], the first reception circuit, in operation, receives the first reception signal in a transmission period of the second transmission signal.

[11] In the indicated position detecting device according to any one of [8] to [10], the second reception circuit, in operation, receives the second reception signal in a transmission period of the first transmission signal.

[12] In the indicated position detecting device according to any one of [8] to [11], a guard interval is provided between a reception period of the first reception signal and a reception period of the second reception signal.

[13] An indicated position detecting method for detecting a position indicated by an indicator includes transmitting a first transmission signal related to first processing of detecting the position indicated by the indicator, and transmitting a second transmission signal related to second processing different from the first processing, wherein a waveform of the first transmission signal and a waveform of the second transmission signal are orthogonal to each other in the same period.

[14] An indicated position detecting method for detecting a position indicated by an indicator includes transmitting a first transmission signal related to first processing of detecting the position indicated by the indicator, transmitting a second transmission signal related to second processing of detecting the position indicated by the indicator, receiving a first reception signal related to the first processing, and receiving a second reception signal related to the second processing, a waveform of the first reception signal and a waveform of the second reception signal being orthogonal to each other in the same period.

### Advantageous Effect

According to the present disclosure, it is possible to suppress a decrease in the accuracy of detecting a position indicated by an indicator.

### BRIEF DESCRIPTION OF THE SEVERAL VIEWS OF THE DRAWINGS

FIG. 1 is an exploded perspective view illustrating an example of a configuration of an electronic apparatus in a present embodiment.

FIG. 2 is a diagram illustrating an example of a configuration of a first sensor and a position detecting circuit in the present embodiment.

FIG. 3 is a diagram illustrating an example of a configuration of a second sensor and a position detecting circuit in the present embodiment.

FIG. 4 is a diagram illustrating an example of a control configuration of a display device in the present embodiment.

FIG. 5 is a diagram of assistance in explaining problems to be solved in the present embodiment.

FIG. 6 is a diagram of assistance in explaining problems to be solved in the present embodiment.

FIG. 7 is a waveform chart related to processing of detecting positions indicated by indicators.

FIG. 8 is a waveform chart related to processing of detecting the positions indicated by the indicators.

FIG. 9 is a diagram illustrating a configuration of an example of a sensor of an indicated position detecting device of a cross point capacitive system.

### DETAILED DESCRIPTION

An embodiment of the present disclosure will be described with reference to the accompanying drawings. Incidentally, in each figure, parts identified by the same reference numerals have the same or similar configuration.

### Description of General Configuration

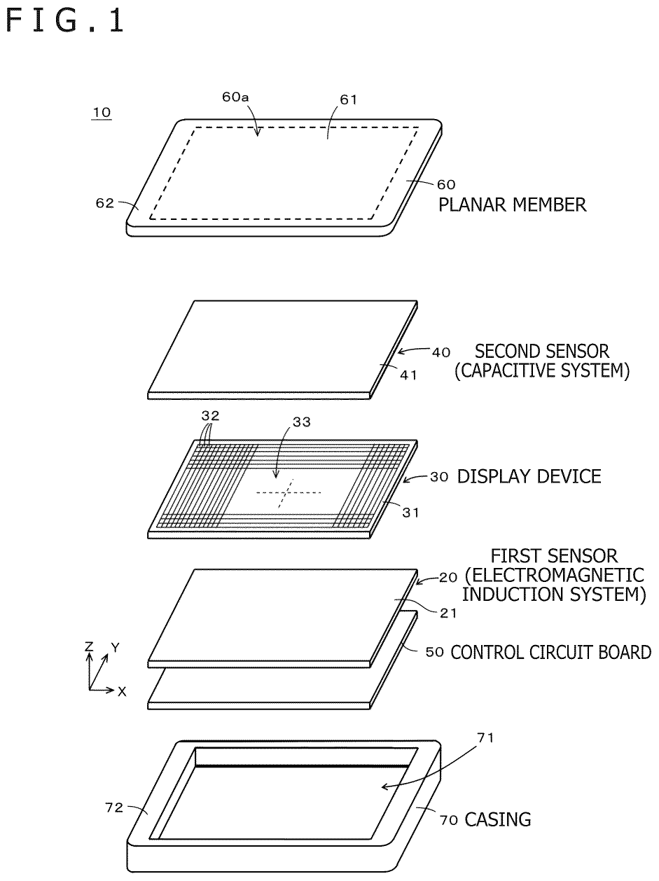

FIG. 1 is an exploded configuration view illustrating an example of a configuration of an electronic apparatus 10 (corresponding to an “indicated position detecting device” according to the present disclosure) in the present embodiment. The electronic apparatus 10 is a pad-type terminal that has a function of detecting a position indicated by an indicator for an electromagnetic induction system constituted by a position indicator such as an electronic pen (which will hereinafter be referred to as a “first indicator”), for example, by a sensor for indicated position detection of the electromagnetic induction system (which will hereinafter be referred to as a “first sensor”) and has a function of detecting a position indicated by an indicator such as a finger or a position indicator (capacitive pen) (which will hereinafter be referred to as a “second indicator”) on a display screen of a display device, by a sensor for indicated position detection of a capacitive system (which will hereinafter be referred to as a “second sensor”), and can thus detect the positions indicated by the first and second indicators simultaneously, by the two sensors.

The electronic apparatus 10 as an example of the pad-type terminal includes a first sensor 20 for the indicated position detection of the electromagnetic induction system, a display device 30, a second sensor 40 for the position detection of the capacitive system, a control circuit board 50, a planar member 60, and a casing 70.

The display device 30 is constituted by a flat display such as a liquid crystal display or an organic electroluminescent (EL) display. The display device 30 includes a display screen 33 in which a large number of display pixels 32 are arranged in an X-axis direction (horizontal direction) and a large number of display pixels 32 are arranged in a Y-axis direction (vertical direction) orthogonal to the X-axis direction on a display substrate 31.

The first sensor 20 is disposed on the undersurface side of the display screen 33 of the display device 30 so as to be superposed on the display device 30. In addition, the second sensor 40 is disposed on the top surface side of the display screen 33 of the display device 30 so as to be superposed on the display screen 33 of the display device 30. Hence, the first sensor 20 and the second sensor 40 are also arranged in superposed relation to each other.

Moreover, a detection region of the first sensor 20 capable of detecting the position indicated by the first indicator, a detection region of the second sensor 40 capable of detecting the position indicated by the second indicator, and a display region of the display screen 33 of the display device 30 are formed in substantially equal size, and are arranged in superposed relation to each other.

Though not illustrated in FIG. 1, a position detecting circuit of the electromagnetic induction system is connected to the first sensor 20, and a position detecting circuit of the capacitive system is connected to the second sensor 40. The first and second position detecting circuits are provided on the control circuit board 50, and are connected to the first sensor 20 and the second sensor 40 by flexible cables, for example. The control circuit board 50 is mounted with a microcomputer for controlling the electronic apparatus 10, a control circuit of the display device 30, other electronic parts, and a copper foil wiring pattern. Incidentally, there may be a plurality of control circuit boards 50 in the electronic apparatus 10. In addition, the first and second position detecting circuits may be provided on another control circuit board than the control circuit board 50.

The planar member 60 is formed of a transparent material such as, for example, glass or resin. The side of one surface 60a of the planar member 60 is formed as an indication surface (operation surface) for indicating positions by the first indicator constituted by the electronic pen and the second indicator such as a finger or an indicating pen. Moreover, the second sensor 40 and the display device 30 are arranged on the side of a surface of the planar member 60 on an opposite side from the one surface 60a of the planar member 60.

The planar member 60 has a shape slightly larger than the indicator detection regions of the first sensor 20 and the second sensor 40. That is, in the planar member 60 in FIG. 1, a region 61 indicated by being enclosed by a dotted line is a region corresponding to the indicator detection regions of the first sensor 20 and the second sensor 40, and a frame region 62 is formed on the periphery of the region 61. Though not illustrated in the figure, the planar member 60 may be formed such that the frame region 62 is set in an opaque state by subjecting the frame region 62 to, for example, silk screen printing or the like, and only the region 61 is maintained in a transparent state.

The casing 70 is formed by a synthetic resin, for example. The casing 70 has a recessed portion 71 formed therein to house the first sensor 20, the display device 30, the second sensor 40, and the control circuit board 50. After the first sensor 20, the display device 30, the second sensor 40, and the control circuit board 50 are housed within the recessed portion 71, the recessed portion 71 is closed by coupling the frame region 62 of the planar member 60 to a frame region 72 of the casing 70 by an adhesive, for example. The electronic apparatus 10 is thus assembled.

Incidentally, the first sensor 20 may be put into a chassis of the display device 30, and the second sensor 40 may be disposed on the first sensor 20 and the display device 30.

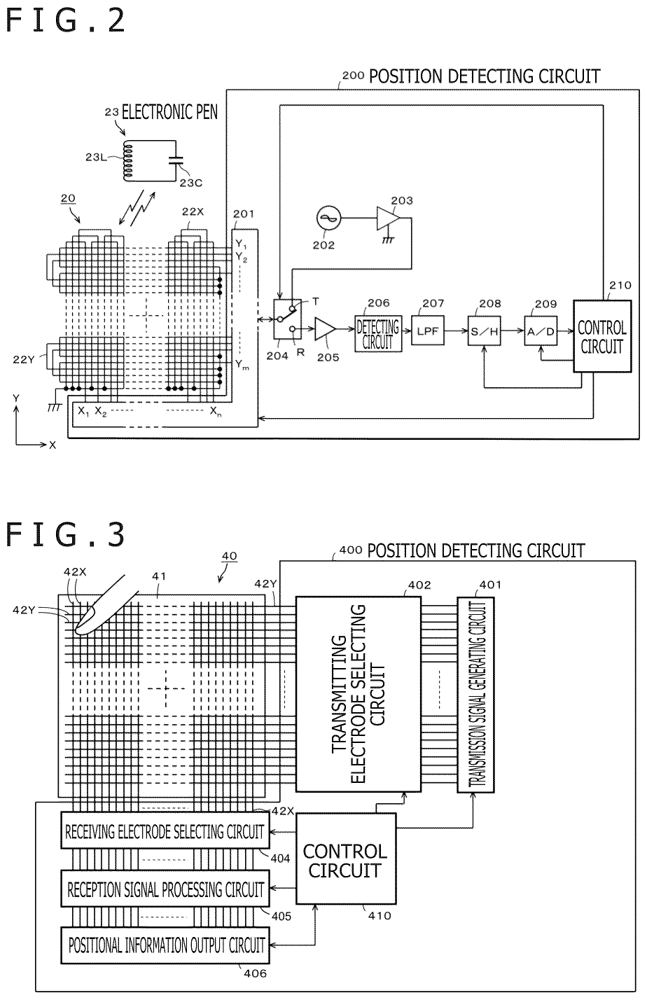

Next, referring to FIG. 2, description will be made of an example of configuration of the first sensor 20 and a position detecting circuit 200 of the electromagnetic induction system. An electronic pen 23 as an example of the first indicator used in conjunction with the first sensor 20 in the present example includes a resonance circuit constituted by a coil 23L and a capacitor 23C connected in parallel with the coil 23L.

The first sensor 20 is formed by arranging an X-axis direction loop coil group 22X on one surface of a wiring board 21 (see FIG. 1), and arranging a Y-axis direction loop coil group 22Y on another surface of the wiring board 21. The X-axis direction loop coil group 22X and the Y-axis direction loop coil group 22Y are each formed by a plurality of rectangular loop coils. In the present embodiment, n loop coils are arranged in the X-axis direction, and m loop coils are arranged in the Y-axis direction. The respective loop coils of the X-axis direction loop coil group 22X and the Y-axis direction loop coil group 22Y are arranged so as to be superposed on each other.

The loop coils constituting the X-axis direction loop coil group 22X are arranged so as to be juxtaposed to each other at equal intervals and sequentially overlap each other in the horizontal direction (X-axis direction) of the detection region for detecting the position indicated by the electronic pen 23. In addition, the loop coils constituting the Y-axis direction loop coil group 22Y are arranged so as to be juxtaposed to each other at equal intervals and sequentially overlap each other in the vertical direction (Y-axis direction) of the detection region.

The position detecting circuit 200 is connected to the first sensor 20. The position detecting circuit 200 includes a selecting circuit 201, an oscillator 202, a current driver 203 constituting a transmitting amplifier, a transmission and reception switching circuit 204, a receiving amplifier 205, a detecting circuit 206, a low-pass filter 207, a sample and hold circuit 208, an analog to digital (A/D) converter circuit 209, and a control circuit 210.

The X-axis direction loop coil group 22X and the Y-axis direction loop coil group 22Y are connected to the selecting circuit 201. The selecting circuit 201 sequentially selects one loop coil of the two loop coil groups 22X and 22Y under control of the control circuit 210.

The oscillator 202 generates an alternating-current signal of a frequency f0. This alternating-current signal is supplied to the current driver 203, is converted therein into a current, and is then sent out to the transmission and reception switching circuit 204. The transmission and reception switching circuit 204 switches a connection destination (a transmitting side terminal T or a receiving side terminal R) to which the loop coil selected by the selecting circuit 201 is connected in each predetermined time under control of the control circuit 210. The current driver 203 is connected to the transmitting side terminal T. The receiving amplifier 205 is connected to the receiving side terminal R.

Hence, at a time of transmission, the alternating-current signal converted into a current in the current driver 203 is supplied to the loop coil selected by the selecting circuit 201 via the transmitting side terminal T of the transmission and reception switching circuit 204. In addition, at a time of reception, an induced voltage generated in the loop coil selected by the selecting circuit 201 is supplied to the receiving amplifier 205 via the selecting circuit 201 and the receiving side terminal R of the transmission and reception switching circuit 204, is amplified therein, and is then sent out to the detecting circuit 206.

The induced voltage amplified in the receiving amplifier 205 is detected by the detecting circuit 206, and is supplied to the A/D converter circuit 209 via the low-pass filter 207 and the sample and hold circuit 208. The A/D converter circuit 209 converts the signal supplied thereto via the low-pass filter 207 and the sample and hold circuit 208 from an analog signal to a digital signal, and supplies the digital signal to the control circuit 210.

The control circuit 210 performs control for detecting an indicated position. That is, the control circuit 210 controls the selection of a loop coil in the selecting circuit 201, signal switching in the transmission and reception switching circuit 204, timing of the sample and hold circuit 208, and the like.

The control circuit 210 performs energization control of the loop coil selected by the selecting circuit 201 in the X-axis direction loop coil group 22X or the Y-axis direction loop coil group 22Y, by switching the transmission and reception switching circuit 204 so as to connect to the transmitting side terminal T. The control circuit 210 thereby makes a magnetic field sent out. The resonance circuit of the electronic pen 23 acts to receive the magnetic field sent out from the loop coil, store magnetic energy, and transmit a magnetic field based on the stored magnetic energy to the first sensor 20.

Next, the control circuit 210 switches the transmission and reception switching circuit 204 so as to connect to the receiving side terminal R. Then, an induced voltage is generated in each of the loop coils of the X-axis direction loop coil group 22X and the Y-axis direction loop coil group 22Y due to the magnetic field transmitted from the electronic pen 23 as a position indicator.

The control circuit 210 calculates coordinate values of the indicated position in the X-axis direction and the Y-axis direction in the detection region of the first sensor 20 on the basis of the voltage value of the induced voltage generated in each of the loop coils. Then, the control circuit 210 detects the position indicated by the electronic pen 23 from the calculated coordinate values. Receiving a result of the detection from the control circuit 210, an external host (personal computer (PC)) controls a screen displayed on the display device 30.

In addition, the control circuit 210 is connected to a control circuit 410 of a position detecting circuit 400 of the second sensor 40, and mutually exchanges synchronizing signals with the control circuit 410 to synchronize the operation of detecting the position indicated by the electronic pen with the operation of detecting the position indicated by a finger or the position indicator. For example, the control circuit 210 transmits, to the control circuit 410, a start signal indicating a start of the operation of detecting the position indicated by the electronic pen. In addition, the control circuit 410 may transmit, to the control circuit 210, a start signal indicating a start of the operation of detecting the position indicated by the finger or the position indicator. Separately from the control circuit 210 and the control circuit 410, a control unit may be provided which synchronizes the operation of detecting the position indicated by the electronic pen and the operation of detecting the position indicated by the finger or the position indicator with each other between the control circuit 210 and the control circuit 410.

Next, referring to FIG. 3, description will be made of an example of configuration of the second sensor 40 and the position detecting circuit 400. The second sensor 40 is configured as a sensor of a cross point capacitive system in order to realize multi-touch detection, which detects a plurality of fingers simultaneously.

The second sensor 40 is constituted by forming an electrode group including a plurality of electrodes having optical transparency, for example, on one surface of a transparent substrate 41 (surface on an opposite side from a surface facing the display screen 33 of the display device 30). The transparent substrate 41 is formed by a glass substrate or a resin film substrate, for example.

The electrode group includes a plurality of first electrodes 42X each formed in the Y-axis direction (vertical direction) and a plurality of second electrodes 42Y each formed in the X-axis direction (horizontal direction) orthogonal to the Y-axis direction. The first electrodes 42X are arranged so as to be separated from each other at predetermined intervals in the X-axis direction. In addition, the second electrodes 42Y are arranged so as to be separated from each other at predetermined intervals in the Y-axis direction. The first electrode 42X and the second electrode 42Y are formed by an optically transparent conductive material, for example, a conductor formed of an indium tin oxide (ITO) film, or a metal mesh.

Moreover, the first electrodes 42X and the second electrodes 42Y are formed on the same one surface side of the transparent substrate 41. Therefore, in cross point regions as intersections of the first electrodes 42X and the second electrodes 42Y orthogonal to each other, the first electrodes 42X and the second electrodes 42Y are electrically insulated from each other by disposing an insulating material between the first electrodes 42X and the second electrodes 42Y.

The position detecting circuit 400 is connected to the second sensor 40. The position detecting circuit 400 includes a transmission signal generating circuit 401, a transmitting electrode selecting circuit 402, a receiving electrode selecting circuit 404, a reception signal processing circuit 405, a positional information output circuit 406, and a control circuit 410.

The position detecting circuit 400 discretely performs position detection processing at predetermined time intervals, for example, at intervals of 10 milliseconds under control of the control circuit 410. The position detecting circuit 400 thereby individually detects a plurality of position indications by the second indicator on the second sensor 40, and obtains respective position detection results.

The transmission signal generating circuit 401 and the transmitting electrode selecting circuit 402 constitute a transmission signal supply circuit. The receiving electrode selecting circuit 404 and the reception signal processing circuit 405 constitute a signal receiving circuit. Moreover, the first electrodes 42X are set as receiving electrodes, and the second electrodes 42Y are set as transmitting electrodes.

The transmission signal generating circuit 401 supplies a predetermined transmission signal to the transmitting electrode selecting circuit 402 in predetermined timing according to control of the control circuit 410. An orthogonal spread code or the like, for example, can be used as the predetermined transmission signal (see Japanese Patent Laid-open No. 2021-99827, for example).

The transmitting electrode selecting circuit 402 selects predetermined second electrodes 42Y (transmitting electrodes) according to selection control of the control circuit 410. A plurality of ones (all, even-numbered ones, or odd-numbered ones) of the second electrodes 42Y that are selected by the transmitting electrode selecting circuit 402 are simultaneously supplied with the transmission signal from the transmission signal generating circuit 401. Incidentally, the transmission signal may be directly transmitted from the transmission signal generating circuit 401 to all of the second electrodes 42Y without the provision of the transmitting electrode selecting circuit 402.

The receiving electrode selecting circuit 404 selects a plurality of ones (all, even-numbered ones, or odd-numbered ones) of the first electrodes 42X according to control of the control circuit 410, and supplies reception signals received simultaneously from the selected first electrodes 42X to the reception signal processing circuit 405.

On the basis of control by the control circuit 410, the reception signal processing circuit 405 detects, by a first electrode 42X, a signal change in the reception signal caused by the indication of a position on the second sensor 40 by the second indicator such as a finger or the position indicator. The reception signal processing circuit 405 supplies a resulting detection output to the positional information output circuit 406.

On the basis of control by the control circuit 410, the positional information output circuit 406 generates an coordinate output as a position detection result, the coordinate output being an indicated position detection signal corresponding to the position indicated by the second indicator such as the finger or the position indicator, from the first electrode 42X at which the signal change in the reception signal has occurred and a second electrode 42Y supplied with the transmission signal at that time from the detection output of the reception signal processing circuit 405. The positional information output circuit 406 outputs the position detection result to the control circuit 410.

Receiving, from the control circuit 210, the position detection result from the positional information output circuit 406, the external host (PC) controls a screen displayed on the display device 30 according to the position detection result.

As described above, the position detecting device according to the present embodiment includes the first sensor 20 and the position detecting circuit 200 of the electromagnetic induction system and includes the second sensor 40 and the position detecting circuit 400 of the capacitive system, and is capable of simultaneously detecting position indications by the first indicator (for example, the electronic pen) and the second indicator (for example, the finger or the position indicator). The electronic apparatus 10 can perform processing such as performing changing control of a display image on the display device 30 according to a result of the detection of the first indicator and a result of the detection of the second indicator.

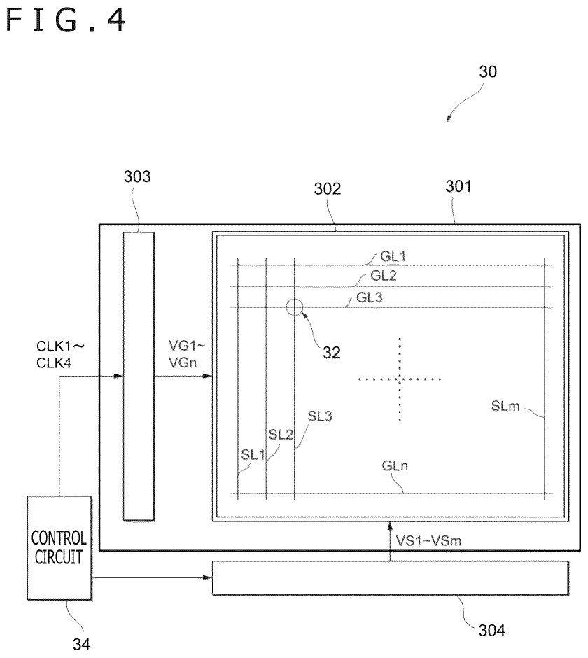

Next, referring to FIG. 4, description will be made of an example of a control configuration of the display device 30. The display device 30 includes a display module 301 (corresponding to a “display” in the present disclosure), a backlight module 302, a gate driver circuit 303, and a source driver circuit 304. A control circuit 34 is mounted on the control circuit board 50 (see FIG. 1). The gate driver circuit 303 and the control circuit 34 are connected to each other via four clock lines not illustrated in the figure.

The display module 301 includes row signal lines GL1 to GLn arranged in the vertical direction, column signal lines SL1 to SLm arranged in the horizontal direction, and display pixels 32 (image elements) arranged at respective points of intersection of the row signal lines GL1 to GLn and the column signal lines SL1 to SLm. The display module 301 drives a corresponding one of the row signal lines GL1 to GLn according to a gate signal VG1 to VGn transmitted from the gate driver circuit 303, and drives the respective display pixels 32 corresponding to source signals VS1 to VSm transmitted from the source driver circuit 304 at luminances indicated by the source signals VS1 to VSm.

The row signal lines GL1 to GLn are gate lines, for example, and n row signal lines GL1 to GLn are arranged in the vertical direction in the display device 30. The row signal lines GL1 to GLn are driven by the corresponding gate signals VG1 to VGn transmitted from the gate driver circuit 303, and relay charge exchanges between gate electrodes of the display pixels 32 corresponding to the points of intersection of the row signal lines GL1 to GLn and the column signal lines SL1 to SLm and the gate driver circuit 303.

The column signal lines SL1 to SLm are source lines, for example, and m column signal lines SL1 to SLm are arranged in the horizontal direction in the display device 30. The column signal lines SL1 to SLm are driven by the corresponding source signals VS1 to VSm transmitted from the source driver circuit 304, and relay charge exchanges between source electrodes of the display pixels 32 corresponding to the points of intersection of the column signal lines SL1 to SLm and the row signal lines GL1 to GLn and the source driver circuit 304.

The display pixels 32 are liquid crystal image elements, for example, and a total of n×m display pixels 32 are arranged at the points of intersection of the row signal lines GL1 to GLn and the column signal lines SL1 to SLm in the display device 30. One of the row signal lines GL1 to GLn is connected to the gate electrode of a display pixel 32, and one of the column signal lines SL1 to SLm is connected to the source electrode of the display pixel 32. When charges are supplied to the gate electrodes of the display pixels 32 via the row signal lines GL1 to GLn connected to the gate electrodes, the display pixels 32 display a corresponding image at luminances according to potentials possessed by the column signal lines SL1 to SLm connected to the source electrodes of the display pixels 32.

The backlight module 302 is a light source disposed on the back side of the display module 301. The backlight module 302 irradiates the display module 301 with light from the back side.

The gate driver circuit 303 is a circuit that drives the row signal lines GL1 to GLn. The gate driver circuit 303 is disposed within the display module 301 when the display device 30 is viewed from the display screen 33 side. The gate driver circuit 303 drives the row signal lines GL1 to GLn in order by outputting the gate signals VG1 to VGn to the corresponding row signal lines GL1 to GLn in timing according to clock signals CLK1 to CLK4 output from the control circuit 34. In addition, the gate driver circuit 303 supplies and extracts charges to and from the gate electrodes of the corresponding display pixels 32 via the driven row signal lines GL1 to GLn.

The source driver circuit 304 is a circuit that drives the column signal lines SL1 to SLm. The source driver circuit 304 is disposed on the lower side of the display module 301 when the display device 30 is viewed from the display screen 33 side. The source driver circuit 304 outputs the source signals VS1 to VSm having potentials set each time for the respective column signal lines SL1 to SLm by the control circuit 34 to the corresponding column signal lines SL1 to SLn in timing according to the control circuit 34. The source driver circuit 304 supplies the source electrodes of the display pixels 32 corresponding to the points of intersection of the row signal lines GL1 to GLn driven by the gate driver circuit 303 and the column signal lines SL1 to SLm with potentials possessed by the source signals VS1 to VSm corresponding to the display pixels 32.

The control circuit 34 is a circuit for controlling the display device 30. At a time of starting the driving of the row signal lines GL1 to GLm by the gate driver circuit 303, the control circuit 34 generates a start signal as a signal indicating the start of the driving, and outputs the start signal to the gate driver circuit 303. In addition, the control circuit 34 generates the clock signals CLK1 to CLK4 for operating the gate driver circuit 303, and outputs the clock signals CLK1 to CLK4 to the gate driver circuit 303 via the four clock lines.

Further, the control circuit 34 generates a clock signal for operating the source driver circuit 304, and outputs the clock signal to the source driver circuit 304. In addition, the control circuit 34 sets potentials to be supplied to the source electrodes of corresponding display pixels 32 via the column signal lines SL1 to SLm, and outputs a signal having information regarding the set potentials to the source driver circuit 304.

### Description of Problems

The electronic apparatus 10 described above presents a challenge of making provision for frame narrowing, which makes the width of a rim (frame) enclosing the flat display (display module 301) narrower in order to realize miniaturization of the electronic apparatus 10 while maintaining the size of the flat display (display module 301). Moreover, in order to make provision for the frame narrowing, the electronic apparatus 10 is desired to have a reduced arrangement space for the loop coils and the signal lines used in the indicated position detecting device for detecting the positions indicated by indicators.

However, when both of an indicated position detecting device of the electromagnetic induction system and an indicated position detecting device of the capacitive system are mounted in one electronic apparatus 10, loop coils used in the indicated position detecting device of the electromagnetic induction system and signal lines used for the transmission of a transmission signal and the reception of a reception signal in the indicated position detecting device of the capacitive system may be arranged in proximity to each other. In this case, due to magnetic coupling (interference) between the loop coils and the signal lines, an electromagnetic noise is mixed into the loop coils from the signal lines used for the transmission of the transmission signal, and an electromagnetic noise is mixed into the signal lines used for the reception of the reception signal from the loop coils. When an electromagnetic noise is mixed into the loop coils from the signal lines used for the transmission of the transmission signal, the S/N ratio of a magnetic field transmitted from the electronic pen 23 and received in the loop coils is decreased, and consequently, the accuracy of indicated position detection in the indicated position detecting device of the electromagnetic induction system is decreased. In addition, when an electromagnetic noise is mixed into the signal lines used for the reception of the reception signal from the loop coils, the S/N ratio of the reception signal is decreased, and consequently, the accuracy of indicated position detection in the indicated position detecting device of the capacitive system is decreased.

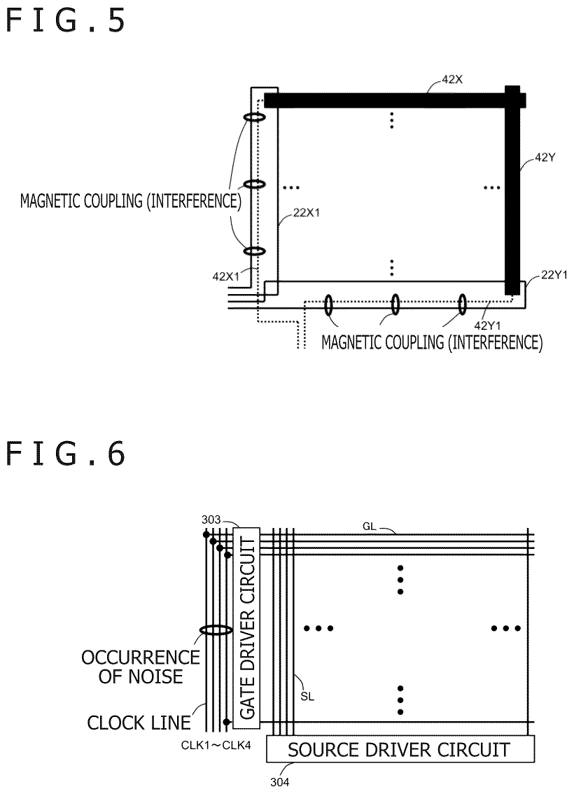

For example, as illustrated in FIG. 5, loop coils 22X1 and 22Y1 used in the indicated position detecting device of the electromagnetic induction system, a signal line 42X1 used for the transmission of the transmission signal in the indicated position detecting device of the capacitive system, and a signal line 42Y 1 used for the reception of the reception signal may be arranged in proximity to each other. In this case, due to magnetic coupling (interference) between the loop coil 22X1 and the signal line 42X1, an electromagnetic noise is mixed into the loop coil 22X1 from the signal line 42X1 used for the transmission of the transmission signal, and thereby the S/N ratio of a magnetic field transmitted from the electronic pen 23 and received in the loop coil 22X1 is decreased, thus decreasing the accuracy of indicated position detection in the indicated position detecting device of the electromagnetic induction system. In addition, due to magnetic coupling (interference) between the loop coil 22Y1 and the signal line 42Y1, an electromagnetic noise is mixed into the signal line 42Y1 used for the reception of a reception signal from the loop coil 22Y1, and thereby the S/N ratio of the reception signal is decreased, thus decreasing the accuracy of indicated position detection in the indicated position detecting device of the capacitive system.

In addition, when the indicated position detecting device of the electromagnetic induction system and the indicated position detecting device of the capacitive system are mounted in one electronic apparatus 10, the loop coils used in the indicated position detecting device of the electromagnetic induction system, the signal lines used in the indicated position detecting device of the capacitive system, and signal lines (for example, clock lines) used for the transmission of driving signals (for example, clock signals) for driving the flat display (display module 301) may be arranged in proximity to each other. In this case, as a result of the mixing of an electromagnetic noise into the loop coils used in the indicated position detecting device of the electromagnetic induction system and the signal lines used for the reception of the reception signal in the indicated position detecting device of the capacitive system from the signal lines used for the transmission of the driving signals, the S/N ratio of the magnetic field transmitted from the electronic pen 23 and received in the loop coils is decreased, thus decreasing the accuracy of position detection in the indicated position detecting device of the electromagnetic induction system, and the S/N ratio of the reception signal is decreased, thus decreasing the accuracy of position detection in the indicated position detecting device of the capacitive system.

For example, as illustrated in FIG. 6, the loop coils (not illustrated) used in the indicated position detecting device of the electromagnetic induction system, the signal lines (not illustrated) used in the indicated position detecting device of the capacitive system, and the signal lines (clock lines) used for the transmission of the driving signals (clock signals CLK1 to CLK4) for driving the flat display (display module 301) may be arranged in proximity to each other. In this case, as a result of the mixing of an electromagnetic noise into the loop coils used in the indicated position detecting device of the electromagnetic induction system and the signal lines used for the reception of the reception signal in the indicated position detecting device of the capacitive system from the clock lines used for the transmission of the clock signals, the S/N ratio of the magnetic field transmitted from the electronic pen 23 and received in the loop coils is decreased, thus decreasing the accuracy of position detection in the indicated position detecting device of the electromagnetic induction system, and the S/N ratio of the reception signal is decreased, thus decreasing the accuracy of position detection in the indicated position detecting device of the capacitive system.

### Description of Configuration for Solving Problems

In order to solve the above-described problems, the electronic apparatus 10 (indicated position detecting device) in the present embodiment includes a first transmission circuit (the X-axis direction loop coil group 22X and the Y-axis direction loop coil group 22Y) that transmits a first transmission signal (electromagnetic induction signal) related to first processing of detecting a position indicated by an indicator (electronic pen 23) by the electromagnetic induction system, a second transmission circuit (transmission signal generating circuit 401) that transmits a second transmission signal (transmission signal) related to second processing of detecting a position indicated by an indicator (a finger or the position indicator (capacitive pen)) by the capacitive system, and a first reception circuit (the X-axis direction loop coil group 22X and the Y-axis direction loop coil group 22Y) that receives a first reception signal (electromagnetic induction signal) related to the first processing in a transmission period of the second transmission signal. Moreover, in the same period, the waveform of the first transmission signal (electromagnetic induction signal) and the waveform of the second transmission signal (transmission signal) are orthogonal to each other. Here, on the basis of a principle of detecting the position indicated by the indicator (electronic pen 23) by the electromagnetic induction system, the center frequency of the first transmission signal (electromagnetic induction signal) and the center frequency of the reception signal (electromagnetic induction signal) are the same in a frequency spectrum represented by the amplitude of a frequency component of each sine wave as a function of frequency. Hence, in a reception period of the first reception signal (electromagnetic induction signal), the waveform of the first reception signal (electromagnetic induction signal) and the waveform of the second transmission signal (transmission signal) are orthogonal to each other, that is, an inner product of the waveform of the first reception signal (electromagnetic induction signal) and the waveform of the second transmission signal (transmission signal) is 0. As a result, the first reception signal in which the mixing in of the electromagnetic noise due to the transmission of the second transmission signal is suppressed can be detected. In a case where the waveform of the first transmission signal (electromagnetic induction signal) and the waveform of the second transmission signal (transmission signal) are orthogonal to each other in the same period, a value obtained by subtracting the wave number of the second transmission signal from the wave number of the first transmission signal, for example, is a positive or negative integer. Incidentally, at the center frequency of the first reception signal (electromagnetic induction signal) in the frequency spectrum, the signal power of the second transmission signal (transmission signal) is 0.

In the present embodiment, the first transmission signal (electromagnetic induction signal) and the second transmission signal (transmission signal) orthogonal to each other are transmitted in the same period in advance in order to be able to demodulate the first reception signal (electromagnetic induction signal) correctly even when an electromagnetic noise is mixed into the loop coils used for the reception of the first reception signal (electromagnetic induction signal) from the signal lines used for the transmission of the second transmission signal (transmission signal) in the reception period of the first reception signal (electromagnetic induction signal). A concept of the two signal waveforms orthogonal to each other is based on orthogonal frequency division multiplexing (OFDM) commonly used in a wireless communication field of wireless local area networks (LANs), the Third Generation Partnership Project (3GPP) (registered trademark), and the like.

That is, by performing processing of obtaining a product of the first reception signal (electromagnetic induction signal) and an internal signal corresponding to the second transmission signal (transmission signal) and integrating the product for a predetermined period as processing at a time of the reception of the first reception signal, it becomes possible to extract the first reception signal in which the mixing in of the electromagnetic noise due to the transmission of the second transmission signal is suppressed (demodulation), or in other words, separate the noise unrelated to the characteristics of the first reception signal desired to be detected. It is consequently possible to suppress a decrease in the accuracy of detecting the position indicated by the indicator (electronic pen 23) by the electromagnetic induction system. Here, the internal signal corresponding to the second transmission signal (transmission signal) is a spread code by which the second transmission signal can be recovered, a locally generated signal and data matching the frequency and pattern of the second transmission signal, and the like. Incidentally, in a case of performing digital demodulation processing, correlation operation processing or discrete Fourier transform (DFT) processing is performed. In addition, in a case of performing analog demodulation processing, orthogonal demodulation processing is performed. Incidentally, the inner product of the waveform of the first reception signal (electromagnetic induction signal) and the waveform of the second transmission signal (transmission signal) does not necessarily need to be 0, and may be equal to or less than a predetermined value to a degree that the first reception signal in which the mixing in of the electromagnetic noise due to the transmission of the second transmission signal is suppressed can be extracted.

In addition, in the present embodiment, the electronic apparatus 10 (indicated position detecting device) includes a first transmission circuit (the X-axis direction loop coil group 22X and the Y-axis direction loop coil group 22Y) that transmits a first transmission signal (electromagnetic induction signal) related to first processing of detecting a position indicated by an indicator (electronic pen 23) by the electromagnetic induction system, a second transmission circuit (transmission signal generating circuit 401) that transmits a second transmission signal (transmission signal) related to second processing of detecting a position indicated by an indicator (a finger or the position indicator (capacitive pen)) by the capacitive system, and a second reception circuit (receiving electrode selecting circuit 404) that receives a second reception signal related to the second processing in a transmission period of the first transmission signal (electromagnetic induction signal). Moreover, in the same period, the waveform of the first transmission signal (electromagnetic induction signal) and the waveform of the second transmission signal (transmission signal) are orthogonal to each other. Here, on the basis of a principle of detecting the position indicated by the indicator (a finger or the position indicator (capacitive pen)) by the capacitive system, the center frequency of the second transmission signal (transmission signal) and the center frequency of the second reception signal are the same in the frequency spectrum. Hence, in a reception period of the second reception signal, the waveform of the first transmission signal (electromagnetic induction signal) and the waveform of the second reception signal are orthogonal to each other, that is, an inner product of the waveform of the first transmission signal (electromagnetic induction signal) and the waveform of the second reception signal is 0. As a result, the second reception signal in which the mixing in of an electromagnetic noise due to the transmission of the first transmission signal is suppressed can be detected. In a case where the waveform of the first transmission signal (electromagnetic induction signal) and the waveform of the second transmission signal (transmission signal) are orthogonal to each other in the same period, a value obtained by subtracting the wave number of the second transmission signal from the wave number of the first transmission signal, for example, is a positive or negative integer. Incidentally, at the center frequency of the second reception signal in the frequency spectrum, the signal power of the first transmission signal (electromagnetic induction signal) is 0.

In the present embodiment, the first transmission signal (electromagnetic induction signal) and the second transmission signal (transmission signal) orthogonal to each other are transmitted in the same period in advance in order to be able to demodulate the second reception signal correctly even when an electromagnetic noise is mixed into the signal lines used for the reception of the second reception signal from the loop coils (the X-axis direction loop coil group 22X and the Y-axis direction loop coil group 22Y) used for the transmission of the first transmission signal (electromagnetic induction signal) in the reception period of the second reception signal.

That is, by performing processing of obtaining a product of the second reception signal and an internal signal corresponding to the first transmission signal (electromagnetic induction signal) and integrating the product for a predetermined period as processing at a time of the reception of the second reception signal, it becomes possible to extract the second reception signal in which the mixing in of the electromagnetic noise due to the transmission of the first transmission signal (electromagnetic induction signal) is suppressed (demodulation), or in other words, separate the noise unrelated to the characteristics of the second reception signal desired to be detected. It is consequently possible to suppress a decrease in the accuracy of detecting the position indicated by the indicator (a finger or the position indicator (capacitive pen)) by the capacitive system. Here, the internal signal corresponding to the first transmission signal (electromagnetic induction signal) is a spread code by which the first transmission signal can be recovered, a locally generated signal and data matching the frequency and pattern of the first transmission signal, and the like. Incidentally, in a case of performing digital demodulation processing, correlation operation processing or DFT processing is performed. In addition, in a case of performing analog demodulation processing, orthogonal demodulation processing is performed. Incidentally, the inner product of the waveform of the first transmission signal (electromagnetic induction signal) and the waveform of the second reception signal does not necessarily need to be 0, and may be equal to or less than a predetermined value to a degree that the second reception signal in which the mixing in of the electromagnetic noise due to the transmission of the first transmission signal is suppressed can be extracted.

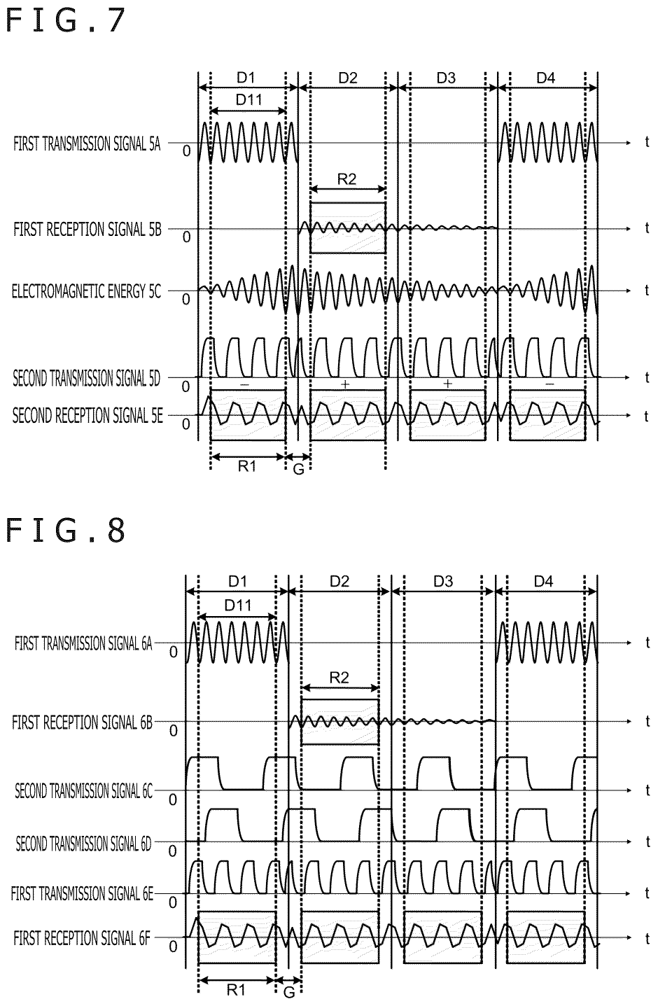

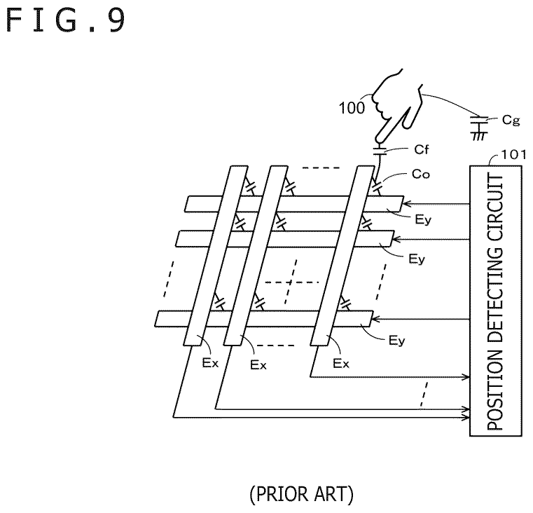

FIG. 7 is a waveform chart related to processing of detecting positions indicated by indicators. In FIG. 7, a first transmission signal 5A represents the waveform (temporal change) of a transmission signal (electromagnetic induction signal) related to processing of detecting the position indicated by an indicator (electronic pen 23) by the electromagnetic induction system. A first reception signal 5B represents the waveform (temporal change) of a reception signal (electromagnetic induction signal) related to the processing of detecting the position indicated by the indicator (electronic pen 23) by the electromagnetic induction system. Electromagnetic energy 5C represents the waveform (temporal change) of a current flowing through the resonance circuit of the electronic pen 23 or in turn a voltage in response to the sending out of the first transmission signal 5A (electromagnetic induction signal). A second transmission signal 5D represents the waveform (temporal change) of a transmission signal related to processing of detecting the position indicated by an indicator (a finger or the position indicator (capacitive pen)) by the capacitive system. A second reception signal 5E represents the waveform (temporal change) of a reception signal related to the processing of detecting the position indicated by the indicator (a finger or the position indicator (capacitive pen)) by the capacitive system. For each of the first transmission signal 5A, the first reception signal 5B, the electromagnetic energy 5C, the second transmission signal 5D, and the second reception signal 5E, an axis of abscissas indicates time (t), and an axis of ordinates indicates magnitude. Incidentally, as for the time on the axis of abscissas, all of the first transmission signal 5A, the first reception signal 5B, the electromagnetic energy 5C, the second transmission signal 5D, and the second reception signal 5E are illustrated on the same time axis.

As indicated by the first transmission signal 5A, in periods D1 and D4, the control circuit 210 performs energization control of the loop coil selected by the selecting circuit 201 in the X-axis direction loop coil group 22X or the Y-axis direction loop coil group 22Y, by switching the transmission and reception switching circuit 204 so as to connect to the transmitting side terminal T. The control circuit 210 thereby makes a magnetic field sent out to the electronic pen 23.

As indicated by the first reception signal 5B, in a period D2, the control circuit 210 makes each of the loop coils of the X-axis direction loop coil group 22X and the Y-axis direction loop coil group 22Y receive a magnetic field transmitted from the electronic pen 23, by switching the transmission and reception switching circuit 204 so as to connect to the receiving side terminal R. An induced voltage is generated in each of the loop coils of the X-axis direction loop coil group 22X and the Y-axis direction loop coil group 22Y due to the received first reception signal 5B. The first reception signal 5B received from the electronic pen 23 by each of the loop coils of the X-axis direction loop coil group 22X and the Y-axis direction loop coil group 22Y gradually decreases with the passage of time.

As indicated by the electromagnetic energy 5C in the period D1, the magnetic energy stored in the resonance circuit of the electronic pen 23 gradually increases because a magnetic field is sent out from the energization-controlled loop coils to the electronic pen 23 by the transmission of the first transmission signal 5A (electromagnetic induction signal). Then, in periods D2 and D3 in which the sending out of the magnetic field from the loop coils to the electronic pen 23 is stopped, the electromagnetic energy stored in the resonance circuit of the electronic pen 23 gradually decreases as the first reception signal 5B (electromagnetic induction signal) is transmitted from the electronic pen 23 to each of the loop coils of the X-axis direction loop coil group 22X and the Y-axis direction loop coil group 22Y.

As indicated by the second transmission signal 5D, in the periods D1 to D4, the control circuit 410 controls the transmission signal generating circuit 401 to make the transmission signal generating circuit 401 transmit a transmission signal to the second electrodes 42Y (transmitting electrodes) through the transmitting electrode selecting circuit 402. The periods D1 and D4 in which the loop coils are energization-controlled by the transmission of the first transmission signal 5A (electromagnetic induction signal) overlap at least a part of the transmission periods D1 to D4 of the second transmission signal 5D transmitted to the second electrodes 42Y (transmitting electrodes). Incidentally, a start time point and an end time point of the periods in which the loop coils are energization-controlled by the transmission of the first transmission signal 5A (electromagnetic induction signal) may be the same as a start time point and an end time point of the transmission periods of the second transmission signal 5D transmitted to the second electrodes 42Y (transmitting electrodes).

As indicated by the second reception signal 5E, in the periods D1 to D4, the control circuit 410 controls the receiving electrode selecting circuit 404 to make the receiving electrode selecting circuit 404 receive the reception signal from the first electrodes 42X.

In the present embodiment, in a period D11 of the period D1, the waveform of the first transmission signal 5A transmitted for performing energization control of the loop coils and the waveform of the second transmission signal 5D transmitted to the second electrodes 42Y (transmitting electrodes) are orthogonal to each other. Here, on the basis of a principle of detecting the position indicated by the indicator (a finger or the position indicator (capacitive pen)) by the capacitive system, the center frequency of the second reception signal 5E received from the first electrodes 42X and the center frequency of the second transmission signal 5D transmitted to the second electrodes 42Y (transmitting electrodes) are the same in the frequency spectrum. Hence, in a reception period R1 of the second reception signal 5E that is equal to the period D11, the waveform of the first transmission signal 5A transmitted for performing energization control of the loop coils and the waveform of the second reception signal 5E received from the first electrodes 42X are orthogonal to each other. In the example illustrated in FIG. 7, in the same period D11, a value obtained by subtracting the wave number (three waves) of the second transmission signal 5D transmitted to the second electrodes 42Y (transmitting electrodes) from the wave number (six waves) of the first transmission signal 5A transmitted for performing energization control of the loop coils is a positive integer (three waves). Incidentally, in the present embodiment, a steep change in the second transmission signal 5D at a start time point and an end time point of the period D11 is avoided by adjusting (for example, shifting by 90 degrees) the phase of the second transmission signal 5D transmitted to the second electrodes 42Y (transmitting electrodes). A decrease in orthogonality between the waveform of the first transmission signal 5A transmitted for performing energization control of the loop coils and the waveform of the second transmission signal 5D transmitted to the second electrodes 42Y (transmitting electrodes) is thereby suppressed when a shift in timing of the transmission of the second transmission signal 5D has occurred.

In the present embodiment, the first transmission signal 5A and the second transmission signal 5D orthogonal to each other are transmitted in the same period D11 in advance in order to be able to demodulate the second reception signal 5E correctly even when an electromagnetic noise is mixed into the signal lines used for the reception of the second reception signal 5E from the first electrodes 42X from the loop coils (the X-axis direction loop coil group 22X and the Y-axis direction loop coil group 22Y) used in the energization control of the first transmission signal 5A in the reception period R1 of the second reception signal 5E.

That is, by performing processing of obtaining a product of the second reception signal 5E received in the reception period R1 and an internal signal corresponding to the first transmission signal 5A transmitted for performing energization control of the loop coils and integrating the product for a predetermined period as processing at a time of the reception of the second reception signal 5E, it becomes possible to extract the second reception signal 5E in which the mixing in of an electromagnetic noise due to the transmission of the first transmission signal 5A is suppressed (demodulation), or in other words, separate the noise unrelated to the characteristics of the second reception signal 5E desired to be detected. It is consequently possible to suppress a decrease in the accuracy of detecting the position indicated by the indicator (a finger or the capacitive pen) by the capacitive system.

In addition, on the basis of a principle of detecting the position indicated by the indicator (electronic pen 23) by the electromagnetic induction system, the center frequency of the first transmission signal 5A transmitted for performing energization control of the loop coils and the center frequency of the first reception signal 5B (electromagnetic induction signal) received from the electronic pen 23 are the same in the frequency spectrum. Hence, in a reception period R2 in which the first reception signal 5B transmitted from the electronic pen 23 is received in the period D2, the waveform of the first reception signal 5B, for example, the waveform of a resonance frequency in the resonance circuit of the electronic pen 23 (the resonance frequency may change according to a pen pressure of the electronic pen 23) and the waveform of the second transmission signal 5D transmitted to the second electrodes 42Y (transmitting electrodes) are orthogonal to each other, that is, an inner product of the waveform of the first reception signal 5B and the waveform of the second transmission signal 5D is 0.

Incidentally, in the reception period R2 in which the first reception signal 5B is received, the waveform of the first reception signal 5B (electromagnetic induction signal) received from the electronic pen 23 and the waveform of the second reception signal 5E received from the first electrodes 42X are orthogonal to each other, that is, an inner product of the waveform of the first reception signal 5B and the waveform of the second reception signal 5E is 0. Moreover, in the same period R2, a value obtained by subtracting the wave number (three waves) of the second reception signal 5E from the wave number (six waves) of the first reception signal 5B is a positive integer (three waves).

In the present embodiment, the first transmission signal 5A and the second transmission signal 5D orthogonal to each other are transmitted in the same period D11 in advance in order to be able to demodulate the first reception signal 5B correctly even when an electromagnetic noise is mixed into the loop coils (the X-axis direction loop coil group 22X and the Y-axis direction loop coil group 22Y) used for the reception of the first reception signal 5B from the electronic pen 23 from the signal lines used for the transmission of the second transmission signal 5D transmitted to the second electrodes 42Y (transmitting electrodes) in the reception period R2 of the first reception signal 5B.

That is, by performing processing of obtaining a product of the first reception signal 5B received in the reception period R2 and an internal signal corresponding to the second transmission signal 5D transmitted to the second electrodes 42Y (transmitting electrodes) and integrating the product for a predetermined period as processing at a time of the reception of the first reception signal 5B, it becomes possible to extract the first reception signal 5B in which the mixing in of an electromagnetic noise due to the transmission of the second transmission signal 5D is suppressed (demodulation), or in other words, separate the noise unrelated to the characteristics of the first reception signal 5B desired to be detected. It is consequently possible to suppress a decrease in the accuracy of detecting the position indicated by the indicator (electronic pen 23) by the electromagnetic induction system.

Incidentally, a period G corresponding to a guard interval is provided between the reception period R1 in which the second reception signal 5E from the first electrodes 42X is received and the reception period R2 of the first reception signal 5B (electromagnetic induction signal) received from the electronic pen 23. It is thereby possible to obtain an effect of being able to mitigate an adverse effect (decrease in the accuracy of detection of the first reception signal 5B and the second reception signal 5E or in turn the accuracy of detection of the indicated positions) in a case of occurrence of a shift in timing of receiving the second reception signal 5E from the first electrodes 42X or a shift in timing of receiving the first reception signal 5B from the electronic pen 23 and an effect of being able to secure a time until the waveform of the first reception signal 5B received from the electronic pen 23 becomes stable after the first transmission signal 5A is transmitted for performing energization control of the loop coils. In addition, in a case where the second transmission signal 5D transmitted to the second electrodes 42Y (transmitting electrodes) is a spread code, and the spread code is switched from a negative (−) to a positive (+), for example, between the reception period R1 and the reception period R2 (see FIG. 7), it is also possible to prevent the accuracy of detection of the first reception signal 5B received from the electronic pen 23 from being decreased by being affected by the switching.

In addition, in the present embodiment, the electronic apparatus 10 (indicated position detecting device) includes a first transmission circuit (the X-axis direction loop coil group 22X and the Y-axis direction loop coil group 22Y) that transmits a first transmission signal (electromagnetic induction signal) related to first processing of detecting a position indicated by an indicator (electronic pen 23) by the electromagnetic induction system, a second transmission circuit (control circuit 34) that transmits a second transmission signal (clock signal) related to second processing of driving a display (display module 301), and a first reception circuit (the X-axis direction loop coil group 22X and the Y-axis direction loop coil group 22Y) that receives a first reception signal (electromagnetic induction signal) related to the first processing in a transmission period of the second transmission signal. Moreover, in the same period, the waveform of the first transmission signal and the waveform of the second transmission signal are orthogonal to each other. Here, on the basis of a principle of detecting the position indicated by the indicator (electronic pen 23) by the electromagnetic induction system, the center frequency of the first reception signal and the center frequency of the first transmission signal are the same in the frequency spectrum. Hence, in a reception period of the first reception signal, the waveform of the first reception signal and the waveform of the second transmission signal are orthogonal to each other, that is, an inner product of the waveform of the first reception signal and the waveform of the second transmission signal is 0. As a result, the first reception signal in which the mixing in of an electromagnetic noise due to the transmission of the second transmission signal is suppressed can be detected. In a case where the waveform of the first transmission signal and the waveform of the second transmission signal are orthogonal to each other in the same period, a value obtained by subtracting the wave number of the second transmission signal from the wave number of the first transmission signal, for example, is a positive or negative integer. Incidentally, at the center frequency of the first reception signal in the frequency spectrum, the signal power density of the second transmission signal is 0.

In the present embodiment, the first transmission signal and the second transmission signal (clock signal) orthogonal to each other are transmitted in the same period in advance in order to be able to demodulate the first reception signal correctly even when an electromagnetic noise is mixed into the loop coils used for the reception of the first reception signal from the signal lines (clock lines) used for the transmission of the second transmission signal in the reception period of the first reception signal.

That is, by performing processing of obtaining a product of the first reception signal (electromagnetic induction signal) and an internal signal corresponding to the second transmission signal (clock signal) and integrating the product for a predetermined period as processing at a time of the reception of the first reception signal, it becomes possible to extract the first reception signal in which the mixing in of the electromagnetic noise due to the transmission of the second transmission signal is suppressed (demodulation), or in other words, separate the noise unrelated to the characteristics of the first reception signal desired to be detected. It is consequently possible to suppress a decrease in the accuracy of detecting the position indicated by the indicator (electronic pen 23) by the electromagnetic induction system. Here, the internal signal corresponding to the second transmission signal (clock signal) is a spread code by which the second transmission signal can be recovered, a locally generated signal and data matching the frequency and pattern of the second transmission signal, and the like. Incidentally, in a case of performing digital demodulation processing, correlation operation processing or DFT processing is performed. In addition, in a case of performing analog demodulation processing, orthogonal demodulation processing is performed. Incidentally, the inner product of the waveform of the first reception signal (electromagnetic induction signal) and the waveform of the second transmission signal (clock signal) does not necessarily need to be 0, and may be equal to or less than a predetermined value to a degree that the first reception signal in which the mixing in of the electromagnetic noise due to the transmission of the second transmission signal is suppressed can be extracted.

In addition, in the present embodiment, the electronic apparatus 10 (indicated position detecting device) includes a first transmission circuit (transmission signal generating circuit 401) that transmits a first transmission signal (transmission signal) related to first processing of detecting a position indicated by an indicator (a finger or the capacitive pen) by the capacitive system, a second transmission circuit (control circuit 34) that transmits a second transmission signal (clock signal) related to second processing of driving a display (display module 301), and a first reception circuit (receiving electrode selecting circuit 404) that receives a first reception signal related to the first processing in a transmission period of the second transmission signal. Moreover, in the same period, the waveform of the first transmission signal (transmission signal) and the waveform of the second transmission signal (clock signal) are orthogonal to each other. Here, on the basis of a principle of detecting the position indicated by the indicator (a finger or the capacitive pen) by the capacitive system, the center frequency of the first reception signal and the center frequency of the first transmission signal are the same in the frequency spectrum. Hence, in a reception period of the first reception signal, the waveform of the first reception signal and the waveform of the second transmission signal (clock signal) are orthogonal to each other, that is, an inner product of the waveform of the first reception signal and the waveform of the second transmission signal is 0. As a result, the first reception signal in which the mixing in of an electromagnetic noise due to the transmission of the second transmission signal is suppressed can be detected. In a case where the waveform of the first transmission signal and the waveform of the second transmission signal are orthogonal to each other, a value obtained by subtracting the wave number of the second transmission signal from the wave number of the first transmission signal, for example, is a positive or negative integer. Incidentally, at the center frequency of the first reception signal in the frequency spectrum, the signal power of the second transmission signal (clock signal) is 0.

In the present embodiment, the first transmission signal and the second transmission signal orthogonal to each other are transmitted in the same period in advance in order to be able to demodulate the first reception signal correctly even when an electromagnetic noise is mixed into the signal lines used for the reception of the first reception signal from the signal lines (clock lines) used for the transmission of the second transmission signal (clock signal) in the reception period of the first reception signal.

That is, by performing processing of obtaining a product of the first reception signal and an internal signal corresponding to the second transmission signal (clock signal) and integrating the product for a predetermined period as processing at a time of the reception of the first reception signal, it becomes possible to extract the first reception signal in which the mixing in of the electromagnetic noise due to the transmission of the second transmission signal is suppressed (demodulation), or in other words, separate the noise unrelated to the characteristics of the first reception signal desired to be detected. It is consequently possible to suppress a decrease in the accuracy of detecting the position indicated by the indicator (a finger or the capacitive pen) by the capacitive system. Here, the internal signal corresponding to the second transmission signal is a spread code by which the second transmission signal can be recovered, a locally generated signal and data matching the frequency and pattern of the second transmission signal, and the like. Incidentally, in a case of performing digital demodulation processing, correlation operation processing or DFT processing is performed. In addition, in a case of performing analog demodulation processing, orthogonal demodulation processing is performed. Incidentally, the inner product of the waveform of the first reception signal and the waveform of the second transmission signal does not necessarily need to be 0, and may be equal to or less than a predetermined value to a degree that the first reception signal in which the mixing in of the electromagnetic noise due to the transmission of the second transmission signal is suppressed can be extracted.

FIG. 8 is a waveform chart related to processing of detecting positions indicated by indicators. In FIG. 8, a first transmission signal 6A represents the waveform (temporal change) of a transmission signal (electromagnetic induction signal) related to processing of detecting the position indicated by an indicator (electronic pen 23) by the electromagnetic induction system. A first reception signal 6B represents the waveform (temporal change) of a reception signal (electromagnetic induction signal) related to the processing of detecting the position indicated by the indicator (electronic pen 23) by the electromagnetic induction system. A second transmission signal 6C represents the waveform (temporal change) of the clock signal CLK1 related to processing of driving the display (display module 301). A second transmission signal 6D represents the waveform (temporal change) of the clock signal CLK2 related to the processing of driving the display (display module 301). A first transmission signal 6E represents the waveform (temporal change) of a transmission signal related to processing of detecting the position indicated by an indicator (a finger or the capacitive pen) by the capacitive system. A first reception signal 6F represents the waveform (temporal change) of a first reception signal related to the processing of detecting the position indicated by the indicator (a finger or the capacitive pen) by the capacitive system. For each of the first transmission signal 6A, the first reception signal 6B, the second transmission signals 6C and 6D, the first transmission signal 6E, and the first reception signal 6F, an axis of abscissas indicates time (t), and an axis of ordinates indicates magnitude. Incidentally, as for the time on the axis of abscissas, all of the first transmission signal 6A, the first reception signal 6B, the second transmission signals 6C and 6D, the first transmission signal 6E, and the first reception signal 6F are illustrated on the same time axis.

As indicated by the first transmission signal 6A, in periods D1 and D4, the control circuit 210 performs energization control of the loop coil selected by the selecting circuit 201 in the X-axis direction loop coil group 22X or the Y-axis direction loop coil group 22Y, by switching the transmission and reception switching circuit 204 so as to connect to the transmitting side terminal T. The control circuit 210 thereby makes a magnetic field sent out to the electronic pen 23.

As indicated by the first reception signal 6B, in a period D2, the control circuit 210 makes each of the loop coils of the X-axis direction loop coil group 22X and the Y-axis direction loop coil group 22Y receive a magnetic field transmitted from the electronic pen 23, by switching the transmission and reception switching circuit 204 so as to connect to the receiving side terminal R. An induced voltage is generated in each of the loop coils of the X-axis direction loop coil group 22X and the Y-axis direction loop coil group 22Y due to the received first reception signal 6B. The first reception signal 6B received from the electronic pen 23 by each of the loop coils of the X-axis direction loop coil group 22X and the Y-axis direction loop coil group 22Y gradually decreases with the passage of time.

As indicated by the second transmission signal 6C, in periods D1 to D4, the control circuit 34 generates the clock signal CLK1 for operating the gate driver circuit 303, and outputs the clock signal CLK1 to the gate driver circuit 303 via the clock line.

As indicated by the second transmission signal 6D, in the periods D1 to D4, the control circuit 34 generates the clock signal CLK2 for operating the gate driver circuit 303, the clock signal CLK2 being different in phase from the clock signal CLK1, and outputs the clock signal CLK2 to the gate driver circuit 303 via the clock line.

As indicated by the first transmission signal 6E, in the periods D1 to D4, the control circuit 410 controls the transmission signal generating circuit 401 to make the transmission signal generating circuit 401 transmit a transmission signal to the second electrodes 42Y (transmitting electrodes) through the transmitting electrode selecting circuit 402.

As indicated by the first reception signal 6F, in the periods D1 to D4, the control circuit 410 controls the receiving electrode selecting circuit 404 to make the receiving electrode selecting circuit 404 receive the reception signal from the first electrodes 42X.

In the present embodiment, in a period D11 of the period D1, the waveform of the second transmission signal 6D output from the control circuit 34 and the waveform of the first transmission signal 6E transmitted to the second electrodes 42Y (transmitting electrodes) are orthogonal to each other. Here, on the basis of a principle of detecting the position indicated by the indicator (a finger or the capacitive pen) by the capacitive system, the center frequency of the first reception signal 6F received from the first electrodes 42X and the center frequency of the first transmission signal 6E transmitted to the second electrodes 42Y (transmitting electrodes) are the same in the frequency spectrum. Hence, in a reception period R1 of the first reception signal 6F that is equal to the period D11, the waveform of the second transmission signal 6D output from the control circuit 34 and the waveform of the first reception signal 6F received from the first electrodes 42X are orthogonal to each other. In the example illustrated in FIG. 8, a value obtained by subtracting the wave number (one wave) of the second transmission signal 6D output from the control circuit 34 from the wave number (three waves) of the first transmission signal 6E transmitted to the second electrodes 42Y (transmitting electrodes) is a positive integer (two waves).

In the present embodiment, the second transmission signal 6D and the first transmission signal 6E orthogonal to each other are transmitted in the same period D11 in advance in order to be able to demodulate the first reception signal 6F correctly even when an electromagnetic noise is mixed into the signal lines used for the reception of the first reception signal 6F received from the first electrodes 42X from the signal line (clock line) used for the transmission of the second transmission signal 6D in the reception period R1 of the first reception signal 6F.

That is, by performing processing of obtaining a product of the first reception signal 6F received in the reception period R1 and an internal signal corresponding to the second transmission signal 6D output from the control circuit 34 and integrating the product for a predetermined period as processing at a time of the reception of the first reception signal 6F, it becomes possible to extract the first reception signal 6F in which the mixing in of an electromagnetic noise due to the transmission of the second transmission signal 6D is suppressed (demodulation), or in other words, separate the noise unrelated to the characteristics of the first reception signal 6F desired to be detected. It is consequently possible to suppress a decrease in the accuracy of detecting the position indicated by the indicator (a finger or the capacitive pen) by the capacitive system.

In addition, in the period D11 of the period D1, the waveform of the second transmission signal 6C output from the control circuit 34 and the waveform of the first transmission signal 6A transmitted for performing energization control of the loop coils are orthogonal to each other. Here, on the basis of a principle of detecting the position indicated by the indicator (electronic pen 23) by the electromagnetic induction system, the center frequency of the first transmission signal 6A transmitted for performing energization control of the loop coils and the center frequency of the first reception signal 6B received from the electronic pen 23 are the same in the frequency spectrum. Hence, in a reception period R2 of the first reception signal 6B received from the electronic pen 23, the waveform of the second transmission signal 6C output from the control circuit 34 and the waveform of the first reception signal 6B received from the electronic pen 23 are orthogonal to each other. In the example illustrated in FIG. 8, in the same period D11, a value obtained by subtracting the wave number (one wave) of the second transmission signal 6C output from the control circuit 34 from the wave number (six waves) of the first transmission signal 6A transmitted for performing energization control of the loop coils is a positive integer (five waves).

In the present embodiment, the second transmission signal 6C and the first transmission signal 6A orthogonal to each other are transmitted in the same period D11 in advance in order to be able to demodulate the first reception signal 6B correctly even when an electromagnetic noise is mixed into the loop coils (the X-axis direction loop coil group 22X and the Y-axis direction loop coil group 22Y) used for the reception of the first reception signal 6B from the electronic pen 23 from the signal line (clock line) used for the transmission of the second transmission signal 6C in the reception period R2 of the first reception signal 6B.

That is, by performing processing of obtaining a product of the first reception signal 6B received in the reception period R2 and an internal signal corresponding to the second transmission signal 6C output from the control circuit 34 and integrating the product for a predetermined period as processing at a time of the reception of the first reception signal 6B, it becomes possible to extract the first reception signal 6B in which the mixing in of an electromagnetic noise due to the transmission of the second transmission signal 6C is suppressed (demodulation), or in other words, separate the noise unrelated to the characteristics of the first reception signal 6B desired to be detected. It is consequently possible to suppress a decrease in the accuracy of detecting the position indicated by the indicator (electronic pen 23) by the electromagnetic induction system.

### Modifications

Incidentally, in the foregoing embodiment, description has been made of an example in which the value obtained by subtracting the wave number of the second transmission signal from the wave number of the first transmission signal is a positive or negative integer in a case where the waveform of the first transmission signal and the waveform of the second transmission signal are orthogonal to each other. However, the present disclosure is not limited to this. For example, in the case where the waveform of the first transmission signal and the waveform of the second transmission signal are orthogonal to each other, it suffices for the inner product of the waveform of the first transmission signal and the waveform of the second transmission signal to be 0, and the value obtained by subtracting the wave number of the second transmission signal from the wave number of the first transmission signal may be 0. In this case, a sine wave (for example, sin(2πmx)), which is a sine wave, is cited as the first transmission signal, and a cosine wave (for example, cos(2πnx) where m=n), which is a sine wave, is cited as the second transmission signal. Incidentally, the phase of the signal transmitted by the pen of the electromagnetic induction system is not known on the side of the first reception circuit that receives the electromagnetic induction signal. Thus, in a case where the first transmission signal and the second transmission signal have waveforms having the same frequency and made different only in phase (example: a sine wave and a cosine wave), it may be difficult to distinguish the first transmission signal and the second transmission signal from each other. Therefore, in a case where the first processing is that of the electromagnetic induction system, the value obtained by subtracting the wave number of the second transmission signal from the wave number of the first transmission signal in the same period is preferably a positive or negative integer.

In addition, in the foregoing embodiment, the electronic apparatus 10 may adopt an in-cell system. The in-cell system is a system that uses the display device 30, and uses the first electrodes 42X or the second electrodes 42Y in the second sensor 40 for the position detection of the capacitive system also as an electrode (for example, a common electrode of a liquid crystal display or a negative electrode of an organic EL display) supplied with a potential necessary to drive the display pixels 32 of the display device 30.

In addition, the foregoing embodiments each merely represent an example of an embodiment in carrying out the present disclosure, and the technical scope of the present disclosure is not to be construed as being limited by these embodiments. That is, the present disclosure can be carried out in various forms without departing from the spirit or main features of the present disclosure.

### DESCRIPTION OF REFERENCE SYMBOLS

10: Electronic apparatus
20: First sensor
21: Wiring board
23: Electronic pen
23L: Coil
23C: Capacitor
22X: X-axis direction loop coil group
22X1: Loop coil
22Y: Y-axis direction loop coil group
22Y1: Loop coil
30: Display device
31: Display substrate
32: Display pixel
33: Display screen
34: Control circuit
40: Second sensor
41: Transparent substrate
42X: First electrode
42X1: Signal line
42Y: Second electrode
42Y1: Signal line
50: Control circuit board
60: Planar member
60a: Surface
61: Region
62: Frame region
70: Casing
71: Recessed portion
72: Frame region
100: Indicator
101: Position detecting circuit
200: Position detecting circuit
201: Selecting circuit
202: Oscillator
203: Current driver
204: Transmission and reception switching circuit
205: Receiving amplifier
206: Detecting circuit
207: Low-pass filter
208: Sample and hold circuit
209: A/D converter circuit
210: Control circuit
301: Display module
302: Backlight module
303: Gate driver circuit
304: Source driver circuit
400: Position detecting circuit
401: Transmission signal generating circuit
402: Transmitting electrode selecting circuit
404: Receiving electrode selecting circuit
405: Reception signal processing circuit
406: Positional information output circuit
410: Control circuit
411: Position indication condition determining circuit

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An indicated position detecting device for detecting a position indicated by an indicator, the indicated position detecting device comprising:
a first transmission circuit; and
a second transmission circuit,
wherein the first transmission circuit, in operation, transmits a first transmission signal related to first processing of detecting the position indicated by the indicator,
wherein the second transmission circuit, in operation, transmits a second transmission signal related to second processing different from the first processing, and
wherein a waveform of the first transmission signal and a waveform of the second transmission signal are orthogonal to each other in a same period.

2. The indicated position detecting device according to claim 1, wherein
a value obtained by subtracting a wave number of the second transmission signal from a wave number of the first transmission signal in the same period is a positive or negative integer.

3. The indicated position detecting device according to claim 1, wherein
the first processing is processing of detecting the position indicated by the indicator by an electromagnetic induction system, and
the second processing is processing of detecting the position indicated by the indicator by a capacitive system.

4. The indicated position detecting device according to claim 1, wherein
a transmission period of the first transmission signal at least partially overlaps a transmission period of the second transmission signal.

5. The indicated position detecting device according to claim 4, wherein
a start time point and an end time point of the transmission period of the first transmission signal are same as a start time point and an end time point of the transmission period of the second transmission signal.

6. The indicated position detecting device according to claim 1, further comprising:
a display, wherein:
the first processing is processing of detecting the position indicated by the indicator on the display by an electromagnetic induction system, and
the second processing is processing of driving the display.

7. The indicated position detecting device according to claim 1, further comprising:
a display, wherein:
the first processing is processing of detecting the position indicated by the indicator on the display by a capacitive system, and
the second processing is processing of driving the display.

8. An indicated position detecting device for detecting a position indicated by an indicator, the indicated position detecting device comprising:
a first transmission circuit;
a second transmission circuit;
a first reception circuit; and
a second reception circuit,
wherein the first transmission circuit, in operation, transmits a first transmission signal related to first processing of detecting the position indicated by the indicator,
wherein the second transmission circuit, in operation, transmits a second transmission signal related to second processing of detecting the position indicated by the indicator,
wherein the first reception circuit, in operation, receives a first reception signal related to the first processing,
wherein the second reception circuit, in operation, receives a second reception signal related to the second processing, and
wherein a waveform of the first reception signal and a waveform of the second reception signal are orthogonal to each other in a same period.

9. The indicated position detecting device according to claim 8, wherein
a value obtained by subtracting a wave number of the second reception signal from a wave number of the first reception signal in the same period is a positive or negative integer.

10. The indicated position detecting device according to claim 8, wherein
the first reception circuit, in operation, receives the first reception signal in a transmission period of the second transmission signal.

11. The indicated position detecting device according to claim 8, wherein
the second reception circuit, in operation, receives the second reception signal in a transmission period of the first transmission signal.

12. The indicated position detecting device according to claim 8, wherein
a guard interval is provided between a reception period of the first reception signal and a reception period of the second reception signal.

13. An indicated position detecting method for detecting a position indicated by an indicator, the indicated position detecting method comprising:
transmitting a first transmission signal related to first processing of detecting the position indicated by the indicator; and
transmitting a second transmission signal related to second processing different from the first processing,
wherein a waveform of the first transmission signal and a waveform of the second transmission signal are orthogonal to each other in a same period.
